(19) United States
(12) Patent Application Publication
(10) Pub. No.: US 2006/0108863 A1
(43) Pub. Date: May 25, 2006

(54) Method for regulating the handling of a vehicle

(75) Inventors: Ralph Gronau, Wetter (DE); Jurgen Woywod, Morfelden (DE)

Correspondence Address: Gerlinde M Nattler;Continental Teves Inc, One Continental Drive, Auburn Hills, MI, 48326, US

(73) Assignee: Continental Teves AG & Co. oHG

(21) Appl. No.: 10/520,485

(22) PCT Filed: Jul. 9, 2003
(86) PCT No.: PCT/EP03/07408

§ 371 Date: Aug. 23, 2005

(30) Foreign Application Priority Data
Jul. 10, 2002 (DE) 102 30 967.1

(51) Int. Cl. B60T 8/88

(52) U.S. Cl. 303/122

(57) ABSTRACT

The present invention relates to a method for controlling the driving performance of a vehicle in which the tire pressure of the wheels prevailing in the individual tires or quantities is monitored by actuators of an actively controllable chassis system with respect to errors. To enhance the stability of the driving performance of a vehicle by means of EBS control units such as ABS, TCS, ESP, ARP, etc. in order to thereby prevent a driving performance of the vehicle that is unstable under driving dynamics aspects or counteract an unstable driving performance, the invention provides that in accordance with the air pressure of the tires on the individual position thereof or the magnitude of error of the actuator on the individual position, a quantity influencing the transverse dynamics of the vehicle is modified when an unstable driving condition is determined or predicted.

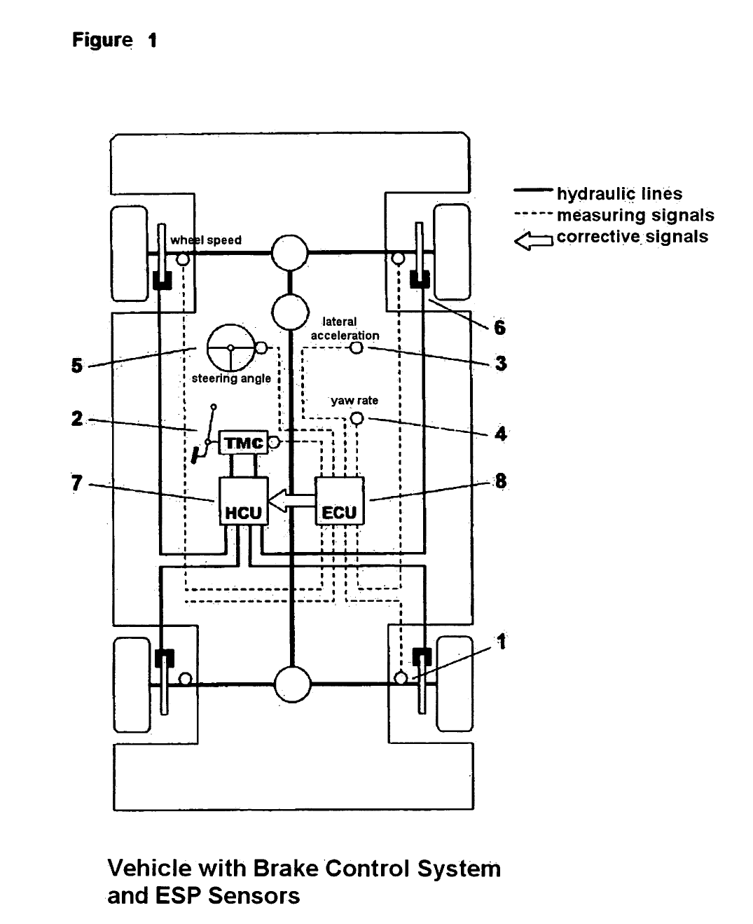

### BACKGROUND OF THE INVENTION

The present invention relates to a method for controlling the driving performance of a vehicle in which at least one vehicle component is monitored for flaws, for instance the tire pressure of the wheels prevailing in the individual tires or the quantities associated with the individual actuators of an actively controllable chassis system.

The method is mainly used to stabilize an unstable driving condition of a vehicle such as a driving condition with a rolling tendency being critical in terms of rollover about a vehicle axle that is oriented in the longitudinal direction of the vehicle, or a driving condition with an oversteering or understeering driving performance, or a driving condition with brake slip or traction slip. Driving conditions of this type are evaluated in control systems for motor vehicles, and control quantities are determined that contribute to stabilizing the respective driving condition.

Most recently air pressure alarm systems are used in vehicles to an increasing extent. Said increase in use is due to a greater awareness of customers to ensure safety and/or due to new legal provisions (USA). Following a series of accidents mainly caused by damaged tires, NHTSA prepared a study about the effect of indirectly and directly measuring tire pressure controlling systems. It has shown that both systems, irrespective of their construction, significantly improve traffic safety by giving an early warning to the driver, because a too low tire pressure can impair the driving performance in a safety-critical way in such a manner that the useful life of the tires is shortened and there is a higher imminent risk of accidents due to damaged tires.

Deviations from the nominal pressure starting from 0.2 bar approximately can be detected exclusively by directly measuring systems like TPMS (Tire Pressure Monitoring System) by means of pressure and temperature sensors in each individual tire. However, additional components required in these systems increase the expenditure compared to indirectly measuring systems, such as the Deflation Detection System (DDS). The latter system detects by pure calculations differences in the pneumatic pressure starting from 30 percent approximately from the comparison of wheel speeds. In this arrangement, the DDS system takes advantage of the circumstance that the tire diameter decreases at a declining tire pressure, which is related to higher rotational speeds of the wheel concerned. The detection of the wheel pressure loss by the Electronic Brake System EBS is based on these rotational speed differences.

Existing tire pressure alarm systems (TPMS, DDS) suffer from the shortcoming that the information is only used to send a warning to the driver. That means it is assumed that the driver will correctly estimate the effects any tire pressure loss has on driving dynamics and change his/her driving style accordingly. If the driver does not realize these effects, there is no gain in safety of the tire pressure alarm.

Further, active chassis systems (air suspension, damper and stabilizer controls) are employed at an increasing rate to comply with higher demands with respect to comfort and driving dynamics.

The above-mentioned systems also have a major influence on the driving performance. When problems occur in a chassis system taking a negative effect on the driving dynamics of the vehicle, this condition is also signaled to the driver. As this occurs, it is also left to the driver how to estimate such impairment.

It is common to both systems that they determine a malfunction in the vehicle (reduced tire pressure, or an actuator of the electronically controllable chassis system is defective or applicable within limits only), yet leave it up to the driver to judge this malfunction. Normally, the driver is hardly aware of said malfunction(s) in quasi-stationary driving situations or in uncritical driving situations. Nevertheless, malfunctions may take effect on the driving performance of the vehicle in such a way that the vehicle is more difficult to master in critical situations, that means in an unstable driving condition where the vehicle does not follow the driver's specifications in the extreme case.

An object of the invention is to enhance the stability of the driving performance of a vehicle by means of EBS control units such as ABS, TCS, ESP, ARP, etc., in order to thereby prevent an unstable driving performance of the vehicle with respect to driving dynamics or counteract an unstable driving performance.

### SUMMARY OF THE INVENTION

According to the invention, this object is achieved in tire pressure alarm systems by way of the following steps: determining the present tire pressure loss, determining or predicting an unstable driving condition and modifying a quantity influencing the transverse dynamics of the vehicle in dependence on the pressure loss on each individual tire position when an unstable driving condition is determined or predicted.

According to the invention, this object is achieved in electronically controllable chassis by the following steps: determining at least one present error of the quantity, determining or predicting an unstable driving condition and modifying a quantity influencing the transverse dynamics of the vehicle in dependence on the magnitude of error of the actuator at each individual position when an unstable driving condition is determined or predicted. An actuator of an active chassis stabilization implies the mechanism performing a movement (forward or backward movement) such as pneumatic cushioning arrangements provided between the wheel suspension and the automobile body, damper and stabilizer controls, and the like.

The quantity is modified advantageously when a cornering maneuver is detected. This is because driving-dynamics-related asymmetrical effects on the driving performance that depend on the position where malfunction occurs are especially encountered in cornering maneuvers (reduced tire pressure or the actuator of the active chassis system is defective or applicable within limits only). In this arrangement, the quantity can also be modified in dependence on the wheel-individual air pressure of the tires and/or the deviation of the magnitude of error.

To make a distinction between straight travel and a cornering maneuver, where a reduced tire pressure or an error of the chassis causes an unstable driving performance of the vehicle that is critical in terms of driving dynamics, it is favorable that it is found out in accordance with the steering angle, the rotational behavior of the wheels, and/or the yaw rate, which wheel suffers from a reduced tire pressure or at which actuator the error of the chassis prevails. The quantity influencing the transverse dynamics is modified in case that e.g. a tire pressure reduced by at least 30% prevails and cornering has been determined. This applies in particular when the reduced tire filling pressure or the magnitude of error of the actuator is detected at an outside wheel in a turn.

To increase driving stability by means of an ESP control unit, it is favorable that the quantity influencing the transverse dynamics is a value of a single-track model influencing an additional yaw torque of a vehicle stability control to be generated. According to a preferred embodiment of the invention, the amount of the friction value which is taken into account in calculating the nominal value of the yaw rate and, hence, for determining the additional yaw torque is limited in accordance with the reduced tire pressure and/or the magnitude of error of the actuator.

To enhance the driving stability by means of an ARP (Active Rollover Protection) control unit it is favorable that the quantity influencing transverse dynamics is a threshold value that determines a driving condition with a lateral acceleration or a rolling tendency critical in terms of rollover. When the threshold value is exceeded, rollover about a vehicle axle oriented in the longitudinal direction of the vehicle will occur. It is advantageous that the threshold value is lowered.

To enhance the driving stability in the presence of simultaneously high transverse dynamics, the invention discloses in a favorable manner that transverse dynamics is reduced during cornering maneuvers (left curve or right curve) where a reduced tire pressure prevails at a wheel, and/or where an error of the quantity prevails at an actuator of the front wheel, in particular when the tire exhibiting the reduced tire pressure or the actuator with the magnitude of the error is associated with the outside wheel in a turn.

It is furthermore favorable that the quantity to be modified is a value (slip value) indicative of the difference between the vehicle reference speed and the wheel rotational speed of each wheel during a cornering maneuver where ABS braking is carried out with ABS control. When the wheel with the reduced tire pressure is a rear wheel in ABS braking, the ABS control is favorably performed according to the SelectLow principle.

According to a favorable design, the value of the modification is taken into account in accordance with a performance graph, in particular in the form of characteristic curves, or a formula.

The stability of driving performance is furthermore enhanced in that in accordance with the reduced tire pressure and the position and number of the wheels with a reduced tire pressure and/or the driving situation, the driving speed is reduced in particular in accordance with a reduction of the vehicle drive torque.

The stability of the driving performance is additionally increased in that in accordance with the magnitude of error and the position of the actuator with the magnitude of error and the number of actuators where an error of the quantity occurs and quantities describing the driving situation, the driving speed is reduced in particular in accordance with a reduction of the vehicle drive torque.

### BRIEF DESCRIPTION OF THE DRAWING

The accompanying drawing represents a vehicle with brake control system and ESP sensor system.

### DETAILED DESCRIPTION OF THE DRAWING

The vehicle includes the typical elements of an ESP system:
four wheel speed sensors (1)
pressure sensor of the tandem master cylinder (THZ) (driver's braking request) (2)
lateral acceleration LA (3)
yaw rate YR (4)
steering wheel angle SWA (5)
four wheel brakes (6) individually actuatable by the ESP
hydraulic unit for the actuation of the wheel brakes (HCU)(7)
vehicle processor system (ECU) (8).

The vehicle includes a tire pressure monitoring system in addition, evaluating the signals of the four wheel speed sensors. Of course sensors located in the tires may also assume this function. No further description is needed because the mode of functioning of systems of this type is known.

The first method of the invention is based on the knowledge that in a vehicle with a tire whose tire pressure is reduced or which is evacuated, usually a driving performance that is unstable in terms of driving dynamics will not occur in straight travel when there is provision of e.g. an emergency or breakdown system that ensures driving further in the evacuated condition in the last mentioned case. If, however, the vehicle follows the course of a curve, instabilities will be encountered in dependence on the driving speed, the driving situation (e.g. when braking while cornering in the ABS, TCS, ARB or ESP case) induced by the tires in which the tire pressure is reduced or up to void. Such instabilities can lead to a driving performance, which the driver did not expect and is no longer able to master. Assist systems are provided for such cases, which influence the driving performance of a vehicle by means of predefinable pressures or brake forces in or at individual wheel brakes and by way of intervening in the management of the driving engine. Such systems concern brake slip control (ABS) meant to prevent the locking of individual wheels during a braking operation, traction slip control (TCS) preventing the driven wheels from spinning, an electronic brake force distribution (EBV) controlling the ratio of brake forces between the front and rear axles of the vehicle, anti-rollover protection (ARP) preventing the vehicle from rolling over its longitudinal axis, and yaw torque control (ESP) ensuring stable driving conditions when the vehicle yaws about its vertical axis. However, these systems are only able to assist the driver to a limited extent when the driving performance of the vehicle is critical under driving-dynamics aspects, because in the presence of a reduced tire pressure or defects of the active chassis, the brake pressures or brake forces introduced by the system cannot come into full effect or the conditions of intervention can be influenced by the reduced tire pressure or the defective actuator of the chassis in such a way that they require modified control strategies to safeguard faultless operation.

Therefore, the method of the invention provides that when tire pressure loss and/or a chassis problem (error information from the chassis system) are detected, the systems, especially the ESP or ARP control algorithms, are adapted to the varying values of lateral tire stiffness. Said adaptation is performed in dependence on the wheel where the tire pressure loss or the chassis problem was detected. This means an axle-selective or side-selective adaptation leads to a quasi ‘asymmetrical’ single-track model, which allows more transverse dynamics in one direction of curve than in the other direction of curve. The control thresholds are also direction-responsively reduced in this situation. The ARP-specific lateral acceleration thresholds and the single-track model limitation are adapted accordingly. The ABS control thresholds are changed in the direction of a reduced transmittal of longitudinal force when transverse force is required (braking in cornering maneuvers). This is done only at the wheel where the tire pressure loss/the chassis problem was detected. A reduction of the longitudinal force permits transmitting higher transverse forces.

When a tire pressure loss/chassis problem appears at the rear axle, modified SelectLow controls will be controlled again to 100% SelectLow, with the control thresholds reduced as well.

The TCS algorithm can also be modified in the same fashion. The degree of adaptation to the modified vehicle characteristics depends on the degree of tire pressure loss/chassis problem and is stored in characteristic curves at the software end.

In the event of a significant pressure loss and/or major chassis problems, it is feasible to limit the driving speed by way of the engine management in order to avoid tire destructions, on the one hand, and allow driving to the nearest workshop, on the other hand.

1-17. (canceled)

18. A method of controlling the driving performance of a vehicle in which at least one vehicle component is monitored for flaws,
comprising the steps of
determining a flaw,
determining or predicting an unstable driving condition and
modifying a quantity influencing the transverse dynamics of the vehicle in dependence on the magnitude of the flaw when an unstable driving condition is determined or predicted.

19. The method according to claim 18, wherein the vehicle has wheels with pneumatic tires, wherein the tire pressure of the wheels prevailing in the individual tires is monitored, and wherein the flaw is a loss of tire pressure.

20. The method as claimed in claim 19,
wherein the quantity is also modified in dependence on the wheel-individual air pressure of the tires.

21. The method as claimed in claim 19,
wherein transverse dynamics is reduced during a cornering maneuver where a reduced tire pressure prevails at the tire of a front wheel, and/or where an error of the quantity prevails at an actuator of the front wheel, in particular when the tire exhibiting the reduced tire pressure or the actuator with the magnitude of error is associated with the outside wheel in a turn.

22. The method as claimed in claim 19,
wherein in accordance with the reduced tire pressure and the position of the tire with a reduced tire pressure and/or the number of the wheels with tires with a reduced tire pressure and quantities describing the driving situation, the driving speed is reduced in particular in accordance with a reduction of the vehicle drive torque.

23. The method according to claim 18, wherein the vehicle has an actively controllable chassis, wherein quantities associated with individual actuators of the chassis system are monitored, and wherein the flaw is at least one error in these quantities.

24. The method as claimed in claim 23,
wherein the quantity is also modified in dependence on the deviation of the magnitude of error.

25. The method as claimed in claim 23,
wherein in accordance with the magnitude of error and the position of the actuator with the magnitude of error and the number of actuators where an error of the quantity occurs and quantities describing the driving situation, the driving speed is reduced in particular in accordance with a reduction of the vehicle drive torque.

26. The method as claimed in claim 23,
wherein an error of the actuator is an error that can be associated with a position of the vehicle and which is in a correlation to a wheel, such as a defective shock absorber, defective (air) cushioning systems, and like devices.

27. The method as claimed in claim 18,
wherein the quantity is modified when a cornering maneuver is detected.

28. The method as claimed in claim 27,
wherein the quantity influencing the transverse dynamics is modified when the flaw occurs at an outside wheel in a turn.

29. The method as claimed in claim 18,
wherein it is found out in accordance with at least one element out of the group consisting of the steering angle, the rotational behavior of the wheels, and the yaw rate, at which location the flaw occurs, and the quantity influencing the transverse dynamics is accordingly modified during cornering.

30. The method as claimed in claim 18,
wherein the quantity influencing the transverse dynamics is a value of a single-track model influencing an additional yaw torque of a vehicle stability control to be generated.

31. The method as claimed in claim 30,
wherein the value is a targeted friction value between tire and road which is limited in accordance with the flaw.

32. The method as claimed in claim 18,
wherein the quantity influencing transverse dynamics is a threshold value that determines a driving condition with a lateral acceleration critical in terms of rollover, and rollover about a vehicle axle oriented in the longitudinal direction of the vehicle will occur when the threshold value is exceeded.

33. The method as claimed in claim 32,
wherein the threshold value is lowered.

34. The method as claimed in claim 18,
wherein the quantity to be modified is a value indicative of the difference between the vehicle reference speed and the wheel rotational speed of each wheel in a cornering maneuver where ABS braking is carried out with ABS control.

35. The method as claimed in claim 34,
wherein when the wheel with the reduced tire pressure is a rear wheel, the ABS control is performed according to the SelectLow principle.

36. The method as claimed in claim 18,
wherein the value of the modification is taken into account in accordance with a performance graph.
